(19) United States
(12) Patent Application Publication
(10) Pub. No.: US 2022/0255157 A1
(43) Pub. Date: Aug. 11, 2022

(54) RECHARGEABLE BATTERY PACK FOR AN ELECTRIC HANDHELD POWER TOOL, AND METHOD

(71) Applicant: Hilti Aktiengesellschaft, Schaan (LI)

(72) Inventors: Rene RICHTER, Augsburg (DE); Alwin MÖHLMANN, Hurlach (DE); Markus BUCHMEYER, Muenchen (DE)

(21) Appl. No.: 17/620,293

(22) PCT Filed: Jun. 19, 2020
(86) PCT No.: PCT/EP2020/067143

§ 371 Date: Dec. 17, 2021

(30) Foreign Application Priority Data
Jul. 1, 2019 (EP) 19183526.3

(51) Int. Cl. H01M 10/653; H01M 10/613; H01M 50/213

(52) U.S. Cl. CPC H01M 10/653; H01M 2220/30; H01M 50/213; H01M 10/613

(57) ABSTRACT

Rechargeable battery pack for an electric handheld power tool, wherein the rechargeable battery pack has a housing shell and a core pack which is accommodated in the housing shell, wherein the housing shell is potted with a potting compound which serves to dissipate heat from the core pack, wherein the potting compound is introduced into the housing shell at least in two layers by way of a first layer and a second layer.

The present invention relates to a rechargeable battery pack for an electric handheld power tool. The rechargeable battery pack has a housing shell and a core pack which is accommodated in the housing shell. The housing shell is potted with a potting compound which serves to dissipate heat from the core pack.

### SUMMARY OF THE INVENTION

The present invention likewise relates to a method for producing a rechargeable battery pack for an electric handheld power tool. The rechargeable battery pack has a housing shell and a core pack which is to be accommodated in the housing shell, wherein a form-fitting sealing/holding element is provided between the housing shell and the core pack in order to hold the core pack fixed in position with respect to the housing shell in at least one direction and to seal off said core pack in the accommodated state. The housing shell is to be potted at least in sections with a potting compound which serves to dissipate heat from the core pack. The core pack can also be referred to as a cell pack, cell package or rechargeable battery cell pack.

Rechargeable battery packs of this kind and corresponding methods for production, in particular for potting rechargeable battery packs, are known in principle from the prior art. It is an object of the present invention to provide a rechargeable battery pack with improved potting within the housing shell, and to a corresponding improved method.

In respect of the rechargeable battery pack, the object is achieved in that the potting compound is introduced into the housing shell in at least two layers by way of a first layer and a second layer. In respect of the method, the object is achieved by the following steps:
filling a first filling quantity of the potting compound into the housing shell;
moving the core pack to its end position within the housing shell, wherein the first filling quantity of the potting compound is partially cured, and
filling a second filling quantity of the potting compound into the housing shell.

The invention includes the finding that rechargeable battery packs have to be potted in a manner as free of faults as possible in order to ensure reliable operation in the long term. This firstly includes avoiding potting of safety-critical components, such as CID components (Current Interrupt Devices). Secondly, it is desirable to avoid potting defects, for example, in the region of a form-fitting sealing/holding element between the housing shell and the core pack.

The method according to the invention provides, for example, the basis for a first layer which is formed by the first filling quantity of the potting compound to be able to completely cover a base of the housing shell. It has been found here that a first layer of this kind of potting compound in the partially cured state already forms adequate sealing in the base region of the housing shell and therefore no potting compound which is to be filled in the further course can penetrate the core pack on the bottom side—at least in the base region—and therefore close any CID components in a disadvantageous manner. At the same time, any plastics tolerances in the typically very long base region of the housing shell can be compensated by the first layer of the potting compound.

In a particularly preferred refinement of the rechargeable battery pack according to the invention, at least one form-fitting sealing/holding element is provided between the housing shell and the core pack in order to hold the core pack fixed in position with respect to the housing shell in at least one direction and to seal off said core pack. In a particularly preferred refinement of the rechargeable battery pack according to the invention, the potting compound is introduced into the housing shell at least in two layers in such a way that the form-fitting sealing/holding element is pressed at least in sections into the first layer of the potting compound. This has the advantage that the form-fitting sealing/holding element is substantially free of potting defects and therefore also adequate sealing in the side region of the housing shell is ensured. As an alternative, the potting compound can be introduced into the housing shell at least in two layers in such a way that the form-fitting sealing/holding element is located only outside the first layer of the potting compound.

It has been found to be advantageous if the second layer has been applied to the partially cured first layer. In a further preferred refinement, the form-fitting sealing/holding element is designed in the form of a tongue-and-groove joint As an alternative, the form-fitting sealing/holding element can be designed as an alternating bung, triangle bung or the like.

It has been found to be advantageous if the first layer of the potting compound substantially completely covers a base of the housing shell. A non-potted residual volume can remain within the housing shell and above the second layer of the potting compound. As an alternative, the housing shell can be completely potted by means of the second layer of the potting compound. The core pack preferably has a cell holder with a plurality of cylindrical rechargeable battery cells.

In respect of the method, it has been found be advantageous if, in the step of filling the first filling quantity of the potting compound into the housing shell, the filling process is performed in such a way that a portion of the form-fitting sealing/holding element that is associated with the housing shell is covered at least in sections by the first filling quantity. In the step of moving the core pack to its end position within the housing shell, a portion of the form-fitting sealing/holding element that is associated with the core pack is preferably pressed into the only partially cured, first filling quantity of the potting compound.

In an alternative refinement of the method, at least one form-fitting sealing/holding element is provided between the housing shell and the core pack in order to hold the core pack fixed in position with respect to the housing shell in at least one direction and to seal off said core pack in the accommodated state, wherein, in the step of filling the first filling quantity of the potting compound into the housing shell, the filling process is performed in such a way that a portion of the form-fitting sealing/holding element that is associated with the housing shell is located only outside a first layer of the potting compound that is formed by the first filling quantity.

In a particularly preferred refinement of the method, in the step of filling the first filling quantity of the potting compound, a base of the housing shell is completely covered by the first filling quantity. A non-potted residual volume preferably remains within the housing shell and above the second layer of the potting compound that is formed by the second filling quantity. As an alternative, a residual volume of this kind can likewise be filled with potting compound.

### BRIEF DESCRIPTION OF THE DRAWINGS

Further advantages can be found in the following description of the figures. Various exemplary embodiments of the present invention are illustrated in the figures. The figures, the description and the claims contain numerous features in combination. A person skilled in the art will expediently also consider the features individually and combine them to form useful further combinations.

In the figures, identical and similar components are denoted by the same reference signs. In the figures:

FIG. 1 shows views of a rechargeable battery pack of the prior art;

FIG. 2 shows a first preferred exemplary embodiment of a rechargeable battery pack according to the invention;

FIG. 3 shows a second preferred exemplary embodiment of a rechargeable battery pack according to the invention;

FIG. 4 shows a schematic illustration of the exemplary embodiment of FIG. 3; and

FIG. 5 shows a preferred exemplary embodiment of a method according to the invention.

### DETAILED DESCRIPTION

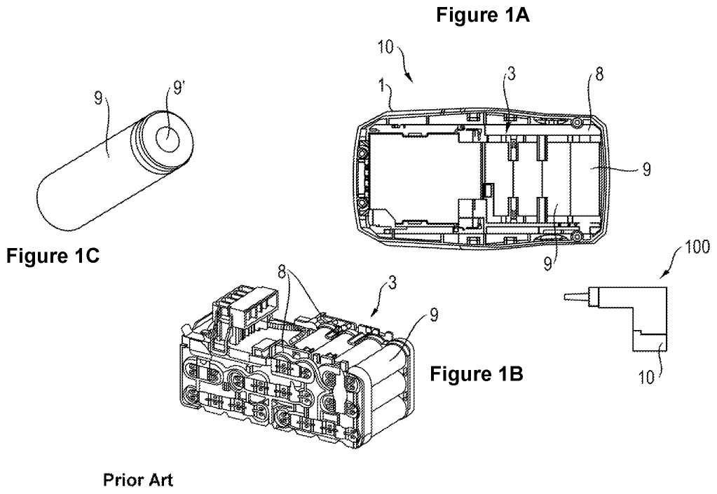

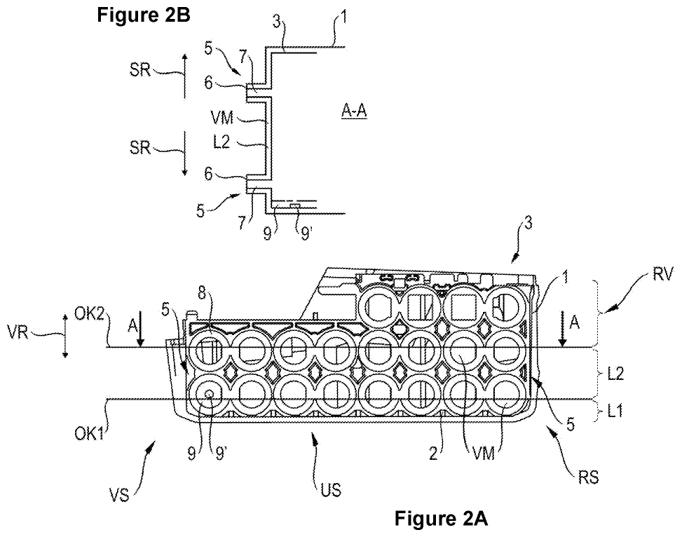

FIG. 1 initially shows various views and components of a rechargeable battery pack 10 of the prior art. The rechargeable battery pack 10 in FIG. 1A is provided for supplying power to an electric handheld power tool 100, here in the form of a rechargeable battery-powered screwdriver. The rechargeable battery pack 10 has a housing shell 1 in which a core pack 3 is accommodated. The core pack 3 is typically barely tolerated with respect to the housing shell 1. The core pack 3 has a cell holder 8 with a plurality of cylindrical rechargeable battery cells 9. FIG. 2B shows a perspective illustration of the core pack. A single cylindrical rechargeable battery cell 9 with a terminal CID component in the form of a CID valve 9′ is shown in FIG. 1C. The CID valve 9′ should be free of a potting compound, not illustrated here.

A preferred exemplary embodiment of a rechargeable battery pack 10 according to the invention is illustrated in FIG. 2. Here, FIG. 2A shows a vertical section through the rechargeable battery pack 10 along an outer surface of the cell holder 8 which at the same time forms an outer border of the core pack 3 (illustrated in FIG. 2 only with one rechargeable battery cell 9). FIG. 2B shows a horizontal section A-A along the section line A in FIG. 2A.

As can be gathered from FIG. 2, the housing shell 1 is potted with a potting compound VM which serves to dissipate heat from the core pack 3. More precisely, the potting compound VM is intended to surround the rechargeable battery cells, not shown here, in the region of the cylindrical casing thereof and in this way to dissipate a quantity of heat from a respective rechargeable battery cell.

According to the invention, the potting compound VM is introduced into the housing shell 1 at least in two layers by way of a first layer L1 and a second layer L2. The first layer L1 of the potting compound VM completely covers a base 2 of the housing shell 1. A first layer 1 of this kind of the potting compound VM already forms adequate sealing in the region of the base 2 of the housing shell 1 in the partially cured state. Therefore, no potting compound VM which is to be filled in the further course can penetrate the core pack 3 on the bottom side US—at least in the region of the base 2 of the housing shell 1—and therefore close any CID components (cf. rechargeable battery cell 9 with CID valve 9′ in FIG. 1C) in a disadvantageous manner In other words, the top edge OK1, shown in FIG. 2A, of the first layer 1 runs just below the CID valve 9′, illustrated by way of example here, of a rechargeable battery cell 9 which is accommodated in the bottom row of the cell holder 8. During the course of a production method, the bottom row which is filled with rechargeable battery cells can be pressed into the only partially cured first layer 1.

A second layer L2 of the potting compound VM has been applied to the partially cured first layer L1 of the potting compound VM. The second layer L2 extends between the top edge OK1, shown in FIG. 2A, of the first layer 1 upward as far as a top edge OK2 of the second layer L2.

In order to prevent the potting compound VM of the second layer 2 from coming into contact with the CID valve 9′ of the rechargeable battery cell 9, which is accommodated in the bottom row of the cell holder 8, in lateral direction SR—as can be seen in FIG. 2B—at least one form-fitting sealing/holding element 5 is provided between the housing shell 1 and the core pack 3 in order to hold the core pack 3 fixed in position with respect to the housing shell 1 in at least one direction and to seal off said core pack. Here, the at least one sealing/holding element 5 is designed in the form of a tongue-and-groove joint 6, 7, wherein a groove 6 is formed, by way of example, on the housing shell 1 and a tongue 7 is formed, by way of example, on the core pack 3 or on the cell holder 8. In the exemplary embodiment of FIG. 2, precisely four sealing/holding element 5 are provided. Two are located on the front side VS of the core pack 3—clearly identifiable in the sectional illustration of FIG. 2B). The two further sealing/holding element 5 are arranged in a corresponding manner on the rear side RS of the core pack 3.

In the exemplary embodiment of FIG. 2, the form-fitting sealing/holding element 5 are only located on the outside the first layer L1 of the potting compound VM. The sealing/holding elements 5 extend in the vertical direction VR only between the top edge OK1, shown in FIG. 2A, of the first layer 1 up to the top edge OK2 of the second layer L2. A non-potted residual volume RV remains within the housing shell 1 and above the second layer L2 of the potting compound VM.

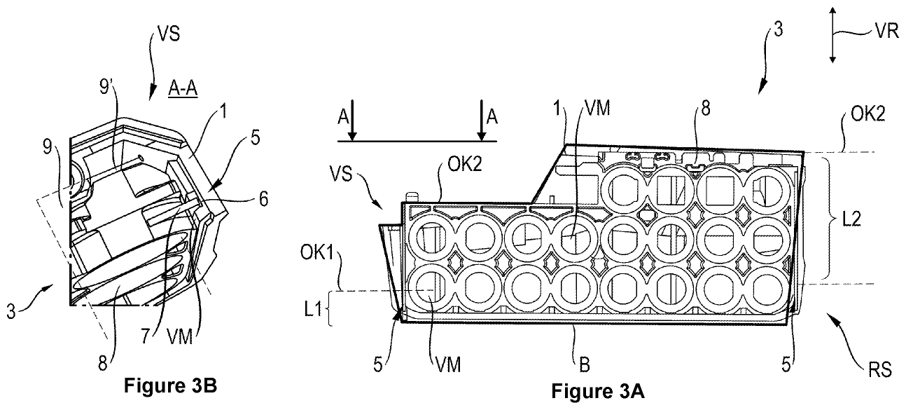

A second preferred exemplary embodiment of a rechargeable battery pack 10 according to the invention is illustrated in FIG. 3. Here, FIG. 3A shows a vertical section through the rechargeable battery pack 10 along an outer surface of the cell holder 8 which at the same time forms an outer border of the core pack 3 (illustrated in FIG. 3 entirely without rechargeable battery cells). FIG. 3B shows a horizontal section A-A along the section line A in FIG. 3A.

The potting compound VM is introduced into the housing shell 1 at least in two layers by way of a first layer L1 and a second layer L2 in the present exemplary embodiment too. In this case, the first layer L1 of the potting compound VM is introduced in such a way that it completely covers a base 2 of the housing shell 1.

In order to prevent the potting compound VM of the second layer 2 from coming into contact with the CID valve 9′ of the rechargeable battery cell 9, which is accommodated in the bottom row of the cell holder 8, in lateral direction SR—as can be seen in FIG. 3B—at least one form—fitting sealing/holding element 5 is provided between the housing shell 1 and the core pack 3 in order to hold the core pack 3 fixed in position with respect to the housing shell 1 in at least one direction and to seal off said core pack. Here, the at least one sealing/holding element 5 is designed in the form of a tongue-and-groove joint 6, 7, wherein a groove 6 is formed, by way of example, on the housing shell 1 and a tongue 7 is formed, by way of example, on the core pack 3 or on the cell holder 8.

In contrast to the exemplary embodiment of FIG. 2, the sealing/holding element 5 already begins at the base 2 of the housing shell 1—with respect to the vertical direction VR. Therefore, filling of the first filling quantity of the potting compound (that forms the first layer L1) into the housing shell the filling process is performed in such a way that a portion of the form-fitting sealing/holding element 5 that is associated with the housing shell 1—that is to say the groove 6 shown in FIG. 2B in this case—is filled at least in sections by the first filling quantity. If the core pack 3 is then moved to its end position shown in FIG. 3, a portion of the form-fitting sealing/holding element 5 that is associated with the core pack—that is to say the tongue 7 shown in FIG. 2B in this case—is pressed into the only partially cured, first filling quantity of the potting compound.

In the exemplary embodiment of FIG. 3, precisely four sealing/holding element 5 are provided. Two are located on the front side VS of the core pack 3—one of which is once again clearly identifiable in the sectional illustration of FIG. 3B). The two further sealing/holding element 5 are arranged in a corresponding manner on the rear side RS of the core pack 3.

In the exemplary embodiment of FIG. 3, the form-fitting sealing/holding element 5 are also located within the first layer L1 of the potting compound VM. The sealing/holding elements 5 extend in the vertical direction VR between the base B, shown in FIG. 3A, of the housing shell 1 and the top edge OK2 of the second layer L2 which exhibits a stepped profile in the exemplary embodiment of FIG. 3.

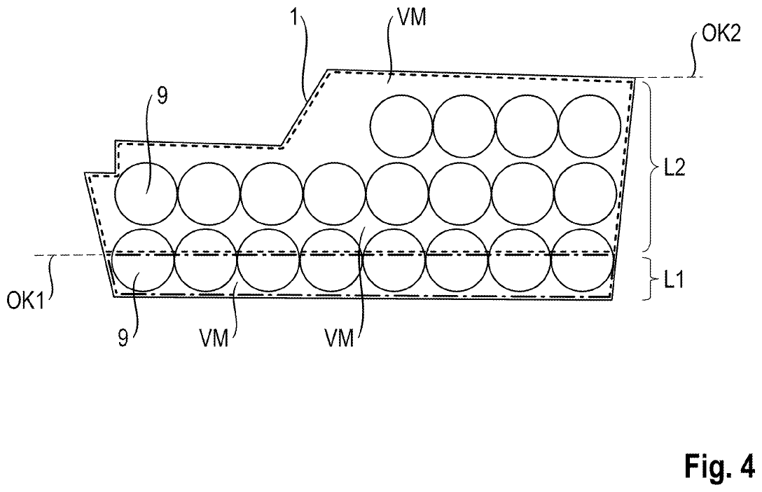

FIG. 4 now shows a simplified schematic illustration of the exemplary embodiment of FIG. 3. As can be gathered from FIG. 4, the housing shell 1 is substantially completely potted by the first layer 1 and the second layer L2 of the potting compound VM, so that substantially no non-potted residual volume remains above the second layer L2. The second layer L2 has been applied to the partially cured first layer L1. During the course of the production method, the bottom row of rechargeable battery cells 9 that is filled with rechargeable battery cells can be pressed into the only partially cured first layer 1.

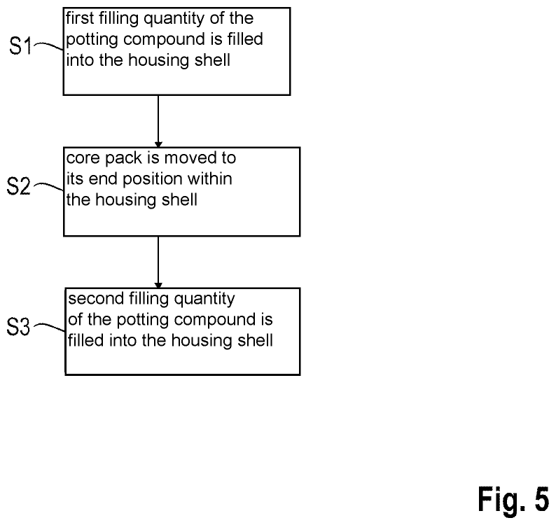

A preferred exemplary embodiment of a method according to the invention for producing a rechargeable battery pack is shown in the form of a flowchart in FIG. 5. The rechargeable battery pack has a housing shell and a core pack which is to be accommodated in the housing shell, wherein the housing shell is to be potted at least in sections with a potting compound which serves to dissipate heat from the core pack.

In a first method step S1, a first filling quantity of the potting compound is filled into the housing shell. Here, at least one form-fitting sealing/holding element in the form of a tongue-and-groove joint is provided between the housing shell and the core pack in order to hold the core pack fixed in position with respect to the housing shell in at least one direction and to seal off said core pack in the accommodated state.

In the first method step S1 of filling the first filling quantity of the potting compound into the housing shell, the filling process is performed in such a way that the groove which is associated with the housing shell (portion of the form-fitting sealing/holding element) is filled at least in sections by the first filling quantity and a base of the housing shell is completely covered by the first filling quantity.

In a subsequent second method step S2, the core pack is moved to its end position within the housing shell, wherein the first filling quantity of the potting compound is partially cured, that is to say is not completely cured. Here, the tongue which is associated with the core pack (portion of the form-fitting sealing/holding element) is pressed into the only partially cured, first filling quantity of the potting compound which is located in the groove. During the course of the second method step S2, a bottom row of the core pack that is filled with rechargeable battery cells is pressed into the only partially cured first layer as it were.

In a subsequent third method step S3, a second filling quantity of the potting compound is filled into the housing shell.

### LIST OF REFERENCE SIGNS

1 Housing shell
2 Base of the housing shell
3 Core pack
5 Form-fitting sealing/holding element
6 Groove
7 Tongue
8 Cell holder
9 Rechargeable battery cell
9′ CID valve
10 Rechargeable battery pack
100 Electric handheld power tool
L1 First layer
L2 Second layer
OK1 Top edge of the first layer
OK2 Top edge of the first layer
RS Rear side
RV Residual volume
S1 First method step
S2 Second method step
S3 Third method step
SR Lateral direction
US Bottom side
VM Potting compound
VR Vertical direction
VS Front side

1-15. (canceled)

16. A rechargeable battery pack for an electric handheld power tool, the rechargeable battery pack comprising:
a housing shell; and
a core pack accommodated in the housing shell;
the housing shell being potted with a potting compound serving to dissipate heat from the core pack, the potting compound being introduced in the housing shell at least in a first layer and a second layer.

17. The rechargeable battery pack as recited in claim 16 wherein the second layer is applied to the first layer while the first layer is in a partially cured state.

18. The rechargeable battery pack as recited in claim 16 further comprising at least one form-fitting seal holder provided between the housing shell and the core pack in order to hold the core pack fixed in position with respect to the housing shell in at least one direction and to seal off the core pack.

19. The rechargeable battery pack as recited in claim 18 wherein the potting compound is introduced into the housing shell in the first and second layers in such a way that the seal holder is pressed at least in sections into the first layer of the potting compound.

20. The rechargeable battery pack as recited in claim 18 wherein the potting compound is introduced into the housing shell in the first and second layers in such a way that the seal holder is located only outside the first layer of the potting compound.

21. The rechargeable battery pack as recited in claim 18 wherein the seal holder is designed in the form of a tongue-and-groove joint.

22. The rechargeable battery pack as recited in claim 16 wherein the first layer of the potting compound completely covers a base of the housing shell.

23. The rechargeable battery pack (as recited in claim 16 wherein a non-potted residual volume remains within the housing shell and above the second layer of the potting compound.

24. The rechargeable battery pack as recited in claim 16 wherein the core pack has a cell holder with a plurality of cylindrical rechargeable battery cells.

25. A method for producing a rechargeable battery pack for an electric handheld power tool, wherein the rechargeable battery pack has a housing shell and a core pack to be accommodated in the housing shell, wherein the housing shell is to be potted at least in sections with a potting compound serving to dissipate heat from the core pack, the method comprising the following steps:
filling a first filling quantity of the potting compound into the housing shell;
moving the core pack to an end position within the housing shell, wherein the first filling quantity of the potting compound is partially cured, and
filling a second filling quantity of the potting compound into the housing shell.

26. The method as recited in claim 25 further comprising providing at least one form-fitting seal holder between the housing shell and the core pack in order to hold the core pack fixed in position with respect to the housing shell in at least one direction and to seal off the core pack in the accommodated state, wherein, in the step of filling the first filling quantity of the potting compound into the housing shell, the filling process is performed in such a way that a portion of the seal holder associated with the housing shell is covered or is filled at least in sections by the first filling quantity.

27. The method as recited in claim 26 wherein in the step of moving the core pack to the end position, a portion of the form-fitting seal holder associated with the core pack is pressed into the only partially cured, first filling quantity of the potting compound.

28. The method as recited in claim 25 further comprising providing at least one form-fitting seal holder between the housing shell and the core pack in order to hold the core pack fixed in position with respect to the housing shell in at least one direction and to seal off said core pack in the accommodated state, wherein, in the step of filling the first filling quantity of the potting compound into the housing shell, the filling process is performed in such a way that a portion of the seal holder associated with the housing shell is located only outside a first layer of the potting compound that is formed by the first filling quantity.

29. The method as recited in claim 25 wherein in the step of filling the first filling quantity of the potting compound, a base of the housing shell is completely covered by the first filling quantity.

30. The method as recited in claim 25 wherein a non-potted residual volume remains within the housing shell and above the second layer of the potting compound that is formed by the second filling quantity.
